(19) United States
(12) Patent Application Publication
(10) Pub. No.: US 2026/0260906 A1
(43) Pub. Date: Sep. 3, 2026

(54) CATALYST LAYER FORMING COMPOSITION, CATALYST LAYER, MEMBRANE ELECTRODE ASSEMBLY, AND POLYMER ELECTROLYTE FUEL CELL

(71) Applicant: AGC INC., Tokyo (JP)

(72) Inventors: Ryogo KATO, Tokyo (JP); Takeshi SHIONO, Tokyo (JP)

(73) Assignee: AGC INC., Tokyo (JP)

(21) Appl. No.: 19/653,321

(22) Filed: Apr. 21, 2026

Related U.S. Application Data
(63) Continuation of application No. PCT/JP2024/037607, filed on Oct. 22, 2024.

(30) Foreign Application Priority Data
Oct. 24, 2023 (JP) 2023-182747

(51) Int. Cl. H01M 4/86; H01M 4/92; H01M 8/10; H01M 8/1004

(52) U.S. Cl. CPC H01M 4/8673; H01M 4/926; H01M 8/1004; H01M 2008/1095

(57) ABSTRACT

To provide a catalyst layer-forming composition, the composition being capable of forming a catalyst layer of a membrane electrode assembly used for a polymer electrolyte fuel cell excellent in power generation performance durability. A catalyst layer-forming composition includes a fluorinated polymer that has a unit having a cyclic ether structure and has an ion exchange group, a catalyst, and a solvent, wherein the fluorinated polymer has an ion exchange capacity of 1.20 meq/g dry resin or less, the catalyst includes a carbon carrier and a metal supported on the carbon carrier, and a ratio of a mass of the fluorinated polymer to a mass of the carbon carrier is 0.6 to 1.5.

### TECHNICAL FIELD

The present invention relates to a catalyst layer-forming composition, a catalyst layer, a membrane electrode assembly, and a polymer electrolyte fuel cell.

### BACKGROUND ART

It is known that a membrane electrode assembly of a polymer electrolyte fuel cell includes an anode having a first catalyst layer, a cathode having a second catalyst layer, and a polymer electrolyte membrane disposed between the anode and the cathode.

Since oxygen is supplied from the cathode side during operation of the polymer electrolyte fuel cell, performance of the polymer electrolyte fuel cell can be further improved if oxygen transport resistance at the cathode is reduced. Thus, Patent Document 1 discloses that a fluorinated polymer that is excellent in oxygen permeability and includes a unit having a cyclic structure is used for a catalyst layer of a cathode.

### PRIOR ART DOCUMENTS

### Patent Documents

Patent Document 1: WO2021/079904

### DISCLOSURE OF INVENTION

### Technical Problem

In recent years, polymer electrolyte fuel cells have been required to have further improved power generation performance durability. The present inventors have conducted studies on a polymer electrolyte fuel cell including a catalyst layer formed using a material as described in Patent Document 1 and found that there is room for improvement in power generation performance durability (e.g., in a high-humidity environment (e.g., at an in-cell relative humidity of 100% RH)).

Here, being excellent in power generation performance durability means that a decrease in voltage is suppressed even when the potential is repeatedly varied.

An object of the present invention is to provide a catalyst layer-forming composition, the composition being capable of forming a catalyst layer of a membrane electrode assembly used for a polymer electrolyte fuel cell excellent in power generation performance durability.

Another object is to provide a catalyst layer applicable to a catalyst layer of a membrane electrode assembly used for a polymer electrolyte fuel cell excellent in power generation performance durability.

A further object is to provide a membrane electrode assembly and a polymer electrolyte fuel cell related to the above.

### Solution to Problem

As a result of intensive studies on the above problem, the present inventors have found that the above objects can be achieved by the following configurations.

[1]

A catalyst layer-forming composition, the composition including:
a fluorinated polymer that has a unit having a cyclic ether structure and has an ion exchange group;
a catalyst; and
a solvent,
wherein the fluorinated polymer has an ion exchange capacity of 1.20 meq/g dry resin or less,
the catalyst includes a carbon carrier and a metal supported on the carbon carrier, and
a ratio of a mass of the fluorinated polymer to a mass of the carbon carrier is 0.6 to 1.5.
   [2]

The catalyst layer-forming composition according to [1], wherein the fluorinated polymer has a softening temperature of 160° C. or higher.

[3]

The catalyst layer-forming composition according to [1] or [2], wherein a content of the unit having a cyclic ether structure is 60 mol % or more relative to all units in the fluorinated polymer.

[4]

The catalyst layer-forming composition according to any one of [1] to [3], wherein the carbon carrier has a specific surface area of 150 m²/g or more.

[5]

The catalyst layer-forming composition according to any one of [1] to [4], wherein the metal is platinum or a platinum alloy.

[6]

The catalyst layer-forming composition according to any one of [1] to [5], wherein the fluorinated polymer has an ion exchange capacity of 0.90 to 1.20 meq/g dry resin.

[7]

A catalyst layer including:
a fluorinated polymer that has a unit having a cyclic ether structure and has an ion exchange group;
and a catalyst,
wherein the fluorinated polymer has an ion exchange capacity of 1.20 meq/g dry resin or less,
the catalyst includes a carbon carrier and a metal supported on the carbon carrier, and
a ratio of a mass of the fluorinated polymer to a mass of the carbon carrier is 0.6 to 1.5.
   [8]

A membrane electrode assembly including an anode having a first catalyst layer, a cathode having a second catalyst layer, and a polymer electrolyte membrane disposed between the anode and the cathode,
wherein the second catalyst layer is the catalyst layer as defined in [7].
   [9]

A polymer electrolyte fuel cell including the membrane electrode assembly as defined in [8].

### Advantageous Effects of Invention

According to the present invention, a catalyst layer-forming composition, the composition being capable of forming a catalyst layer of a membrane electrode assembly used for a polymer electrolyte fuel cell excellent in power generation performance durability, can be provided.

In addition, a catalyst layer applicable to a catalyst layer of a membrane electrode assembly used for a polymer electrolyte fuel cell excellent in power generation performance durability can be provided.

Furthermore, a membrane electrode assembly and a polymer electrolyte fuel cell related to the above can be provided.

### BRIEF DESCRIPTION OF DRAWINGS

FIG. 1 is a sectional view showing an example of a membrane electrode assembly.

### DESCRIPTION OF EMBODIMENTS

The definitions of the following terms apply throughout the present specification and the claims unless otherwise specified.

The term “ion exchange group” means a group that can exchange at least some of the ions included in the group for other ions, and examples thereof include acid-form sulfonic acid functional groups and acid-form carboxylic acid functional groups described below.

The term “acid-form sulfonic acid functional group” is a general term for an acid-form sulfonic acid group (—SO₃H) and a salt-form sulfonate group (—SO₃M², where M² is an alkali metal or a quaternary ammonium cation).

The term “acid-form carboxylic acid functional group” is a general term for an acid-form carboxylic acid group (—COOH) and a salt-form carboxylate group (—COOM¹, where M¹ is an alkali metal or a quaternary ammonium cation).

The term “unit” in a polymer (e.g., a fluorinated polymer) means an atomic group formed by polymerization of a monomer and derived from one molecule of the monomer. The unit may be an atomic group formed directly by a polymerization reaction, or may be an atomic group derived by treating a polymer obtained by the polymerization reaction thereby to convert a part of the atomic group into another structure. A constituent unit derived from an individual monomer may be expressed as the name of the monomer followed by “unit”.

A unit represented by formula (u11) is expressed as unit (u11). Units represented by other formulae are expressed likewise.

A numerical range expressed using “to” means a range including numerical values recited before and after “to” as lower and upper limit values. For numerical ranges recited stepwise in the present specification, the upper or lower limit value recited in a certain numerical range may be replaced with the upper or lower limit value of another numerical range recited stepwise. For numerical ranges recited in the present specification, the upper or lower limit value recited in a certain numerical range may be replaced with a value shown in Examples.

### [Catalyst Layer-Forming Composition]

A catalyst layer-forming composition according to the present invention (hereinafter, also referred to as “the present composition”) includes a fluorinated polymer that has a unit (hereinafter, also referred to as “unit A”) including a cyclic ether structure and has an ion exchange group, a catalyst, and a solvent, wherein the fluorinated polymer has an ion exchange capacity of 1.20 meq/g dry resin or less, the catalyst includes a carbon carrier and a metal supported on the carbon carrier, and the ratio (hereinafter, also referred to as “I/C”) of the mass of the fluorinated polymer to the mass of the carbon carrier is 0.6 to 1.5.

Hereinafter, a fluorinated polymer having unit A and having an ion exchange group, the fluorinated polymer having an ion exchange capacity of 1.20 meq/g dry resin or less, is also referred to as “polymer H”.

For a fluorinated polymer included in a catalyst layer, it is known to use a fluorinated polymer having a large ion exchange capacity in order to improve proton conductivity. However, the present inventors have found that, when a fluorinated polymer having a high ion exchange capacity is used, the moisture content in the catalyst layer tends to increase, and the moisture may cause oxidation and elution of a metal in the catalyst, resulting in inferior power generation performance durability. The fluorinated polymer having a high ion exchange capacity can enter pore portions of the catalyst and come into contact with the catalyst in the pore portions to reduce catalytic activity.

Thus, the present inventors have presumed that when a fluorinated polymer having an ion exchange capacity of 1.20 meq/g dry resin or less is used while the fluorinated polymer further includes unit A, the fluorinated polymer is in a rigid state, and its entry into pore portions in the catalyst can be suppressed, so that power generation performance durability can be improved. Adjusting I/C to a specific range is also believed to contribute to the improvement of power generation performance.

For higher efficiency, higher output, and higher durability of a fuel cell, I/C is 0.6 to 1.5, preferably 0.7 to 1.5, more preferably 0.7 to 1.2. I/C is preferably 0.7 or more, more preferably 0.8 or more, and is preferably 1.2 or less, more preferably 1.0 or less, still more preferably 0.9 or less.

From the viewpoint of storage properties, the solids concentration of the present composition is preferably 3.0 mass % or more, more preferably 4.0 mass % or more, still more preferably 5.0 mass % or more, and from the viewpoint of coating properties, it is preferably 10.0 mass % or less, more preferably 8.0 mass % or less, still more preferably 7.0 mass % or less.

Here, the solids concentration is calculated by the following method on the basis of masses of the present composition before and after heating.

After 1 g of the present composition is heated at 180° C. for 180 minutes, the mass of the residue is weighed, and the solids concentration is calculated by the following formula.

Solids concentration (mass %)=100×(mass of residue)/(mass of present composition).

### <Polymer H>

The present composition includes polymer H.

Polymer H is a polymer having unit A and having an ion exchange group, and has an ion exchange capacity of 1.20 meq/g dry resin or less.

The ion exchange capacity of polymer H is 1.20 meq/g dry resin or less, preferably 1.16 meq/g dry resin or less, more preferably 1.13 meq/g dry resin or less, still more preferably 1.10 meq/g dry resin or less.

From the viewpoint of excellent power generation characteristics, the ion exchange capacity of polymer H is preferably 0.90 meq/g dry resin or more, more preferably 1.00 meq/g dry resin or more, still more preferably 1.05 meq/g dry resin or more, particularly preferably 1.08 meq/g dry resin or more. The ion exchange capacity is also preferably 0.90 to 1.20 meq/g dry resin.

The ion exchange capacity of polymer H is determined by a method described in EXAMPLES given below.

From the viewpoint of providing a catalyst layer more excellent in oxygen permeability, unit A is preferably at least one unit selected from the group consisting of unit (u11), unit (u12), unit (u21), unit (u22), and unit (u24).

Unit A is also preferably a unit having a cyclic ether structure and having no ion exchange group.

In the present specification, unit (u11), unit (u12), unit (u21), unit (u22), and unit (u24) may be collectively referred to as “specific cyclic ether structure units”.

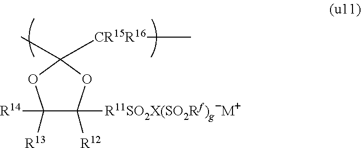

R¹¹ is a divalent perfluoroalkylene group optionally having an etheric oxygen atom. When the perfluoroalkylene group has an etheric oxygen atom, the number of oxygen atoms may be one or two or more. The etheric oxygen atom may be positioned within a carbon-carbon bond of the perfluoroalkylene group, or may be positioned at a carbon atom bond terminal. The perfluoroalkylene group may be linear or branched, and is preferably linear.

R¹², R¹³, R¹⁵, and R¹⁶ are each independently a monovalent perfluoroalkyl group optionally having an etheric oxygen atom, or a fluorine atom. From the viewpoint of high polymerization reactivity, at least one of R¹⁵ and R¹⁶ is preferably a fluorine atom, and more preferably, both are fluorine atoms.

R¹⁴ is a monovalent perfluoroalkyl group optionally having an etheric oxygen atom, a fluorine atom, or a group represented by —R¹¹(SO₂X(SO₂R^{f})ₐ)⁻M⁺. When the perfluoroalkyl group has an etheric oxygen atom, the number of oxygen atoms may be one or two or more. The etheric oxygen atom may be positioned within a carbon-carbon bond of the perfluoroalkyl group, or may be positioned at a carbon atom bond terminal. The perfluoroalkyl group may be linear or branched, and is preferably linear. In formula (u11), when two R¹¹'s are included, the two R¹¹'s may be the same as or different from each other.

M⁺ is H⁺, a monovalent metal cation (e.g., a potassium ion or a sodium ion), or an ammonium ion in which one or more hydrogen atoms are optionally substituted with a hydrocarbon group (e.g., a methyl group or an ethyl group), and H⁺ is preferred from the viewpoint of high conductivity.

R^{f} is a linear or branched perfluoroalkyl group optionally having an etheric oxygen atom. The number of carbon atoms of the perfluoroalkyl group is preferably 1 to 8, particularly preferably 1 to 6. When two or more R^{f}'s are present, the two or more R^{f}'s may be the same as or different from each other.

X is an oxygen atom, a nitrogen atom, or a carbon atom, and when X is an oxygen atom, a=0; when X is a nitrogen atom, a=1; and when X is a carbon atom, a=2.

Specific examples of the —(SO₂X(SO₂R^{f})ₐ)⁻M⁺ group include a sulfonic acid group (—SO₃⁻M⁺ group), a sulfonimide group (—SO₂N(SO₂R^{f})⁻M⁺ group), and a sulfonmethide group (—SO₂C(SO₂R^{f})₂)⁻M⁺ group).

Unit (u11) is preferably unit (u11-1).

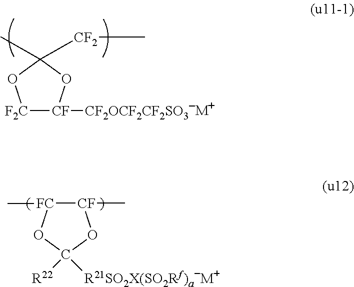

R²¹ is a perfluoroalkylene group having 1 to 6 carbon atoms, or a perfluoroalkylene group having 2 to 6 carbon atoms and having an etheric oxygen atom within a carbon-carbon bond. When the perfluoroalkylene group has an etheric oxygen atom, the number of oxygen atoms may be one or two or more. The perfluoroalkylene group may be linear or branched, and is preferably linear.

R²² is a fluorine atom, a perfluoroalkyl group having 1 to 6 carbon atoms, a perfluoroalkyl group having 2 to 6 carbon atoms and having an etheric oxygen atom within a carbon-carbon bond, or a group represented by —R²¹(SO₂X(SO₂R^{f})ₐ)⁻M⁺. When the perfluoroalkyl group has an etheric oxygen atom, the number of oxygen atoms may be one or two or more. The perfluoroalkyl group may be linear or branched, and is preferably linear. In formula (u12), when two R²¹'s are included, the two R²¹'s may be the same as or different from each other.

M⁺, R^{f}, X, and a respectively have the same meanings as M⁺, R^{f}, X, and a in formula (u11).

Specific examples of unit (u12) include unit (u12-1) and unit (u12-2). In the formulae, M⁺ has the same meaning as M⁺ in formula (u11).

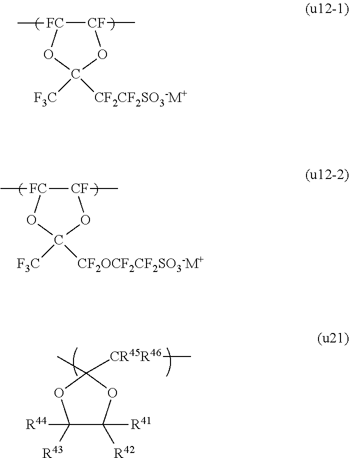

R⁴¹, R⁴², R⁴³, R⁴⁴, R⁴⁵, and R⁴⁶ are each independently a monovalent perfluoroalkyl group optionally having an etheric oxygen atom, or a fluorine atom. When the perfluoroalkyl group has an etheric oxygen atom, the number of oxygen atoms may be one or two or more. The etheric oxygen atom may be positioned within a carbon-carbon bond of the perfluoroalkyl group, or may be positioned at a carbon atom bond terminal. The perfluoroalkyl group may be linear or branched, and is preferably linear.

From the viewpoint of high polymerization reactivity, at least one of R⁴⁵ and R⁴⁶ is preferably a fluorine atom, and particularly preferably, both are fluorine atoms.

Unit (u21) is preferably unit (u21-1).

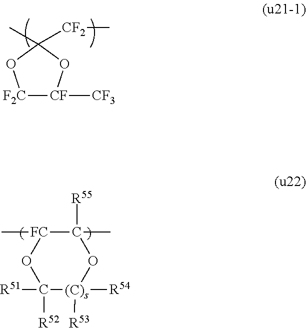

s is 0 or 1, and is preferably 0.

R⁵¹ and R⁵² are each independently a fluorine atom or a perfluoroalkyl group having 1 to 5 carbon atoms, or may be bonded to each other to form a spiro ring (provided that s is 0).

R⁵³ and R⁵⁴ are each independently a fluorine atom or a perfluoroalkyl group having 1 to 5 carbon atoms.

R⁵⁵ is a fluorine atom, a perfluoroalkyl group having 1 to 5 carbon atoms, or a perfluoroalkoxy group having 1 to 5 carbon atoms. From the viewpoint of high polymerization reactivity, R⁵⁵ is preferably a fluorine atom.

The perfluoroalkyl group and the perfluoroalkoxy group may be linear or branched, and are preferably linear.

Unit (u22) is preferably unit (u22-1).

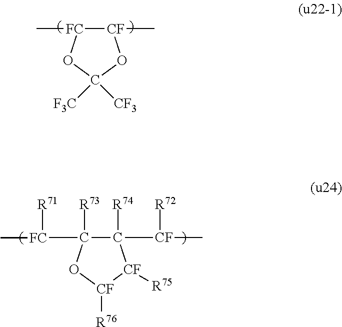

R⁷¹ to R⁷⁶ are each independently a monovalent perfluoroalkyl group optionally having an etheric oxygen atom, or a fluorine atom. When the perfluoroalkyl group has an etheric oxygen atom, the number of oxygen atoms may be one or two or more. The etheric oxygen atom may be inserted within a carbon-carbon bond of the perfluoroalkyl group, or may be inserted at a carbon atom bond terminal. The perfluoroalkyl group may be linear or branched, and is preferably linear.

From the viewpoint of high polymerization reactivity, R⁷¹ to R⁷⁴ are preferably fluorine atoms.

From the viewpoint of providing a catalyst layer more excellent in oxygen permeability, among the specific cyclic ether structure units described above, unit A preferably includes at least one unit selected from the group consisting of unit (u21), unit (u22), and unit (u24), and is more preferably unit (u22).

From the viewpoint of more excellent power generation characteristics of a fuel cell, the content of unit A relative to all units in polymer H is preferably 50 mol % or more, more preferably 55 mol % or more, still more preferably 60 mol % or more.

From the viewpoint of further suppressing the occurrence of cracking of the catalyst layer and from the viewpoint of more excellent power generation characteristics, the content of unit A relative to all units in polymer H is preferably 87 mol % or less, more preferably 80 mol % or less, still more preferably 75 mol % or less.

Polymer H may include only one type of unit A, or may include two or more types of unit A. When two or more types are included, the content means the total amount thereof.

From the viewpoint of excellent power generation characteristics, polymer H preferably includes a unit (hereinafter, also referred to as “unit B”) that does not include a cyclic ether structure and has an ion exchange group.

In each unit included in unit B, the number of ion exchange groups is preferably one or more, more preferably two or more from the viewpoint of easily obtaining a polymer having a high molecular weight while maintaining the content of unit A, and still more preferably two from the viewpoint of ease of monomer synthesis.

Unit B is preferably a perfluoromonomer unit having an ion exchange group, more preferably a perfluoromonomer unit having an acid-form sulfonic acid functional group.

The perfluoromonomer unit is preferably unit (u31), unit (A-1), unit (A-2), or unit (A-3), and from the viewpoint of further improving power generation characteristics of a fuel cell, it is more preferably unit (A-1), unit (A-2), or unit (A-3), still more preferably unit (A-2).

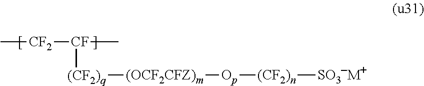

In formula (u31), Z is a fluorine atom or a trifluoromethyl group, q is 0 or 1, m is an integer of 0 to 3, p is 0 or 1, n is an integer of 1 to 12, and m+p>0.

In formula (u31), M⁺ is H⁺, a monovalent metal cation (e.g., a potassium ion or a sodium ion), or an ammonium ion in which one or more hydrogen atoms are optionally substituted with a hydrocarbon group (e.g., a methyl group or an ethyl group), and is preferably H⁺.

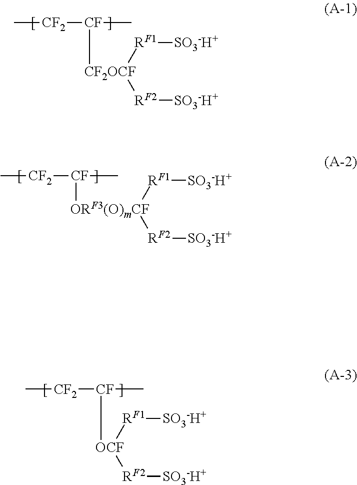

In formula (A-1) to formula (A-3), R^{F1} and R^{F2} are each independently a perfluoroalkylene group having 1 to 3 carbon atoms, or a divalent group derived by substituting —CF₂— of a perfluoroalkylene group with an etheric oxygen atom.

In the divalent group, the etheric oxygen atom may be positioned at a terminal of the perfluoroalkylene group or may be positioned between carbon atoms.

The number of carbon atoms of the divalent group is preferably 1 to 3, more preferably 2 or 3.

Specific examples of R^{F1} and R^{F2} include —CF₂—, —CF₂CF₂—, —CF(CF₃)—, —CF₂CF₂CF₂—, —CF(CF₂CF₃)—, —CF(CF₃) CF₂—, —CF₂CF(CF₃)—, —C(CF₃)(CF₃)—, —CF₂OCF₂CF₂—, and —OCF₂CF₂—.

From the viewpoints of inexpensive raw materials, ease of production, and a further increase in the ion exchange capacity of polymer H, R^{F1} and R^{F2} are each independently preferably a perfluoroalkylene group having 1 or 2 carbon atoms, —CF₂OCF₂CF₂—, or —OCF₂CF₂—. In the case of a perfluoroalkylene group having 2 carbon atoms, it is preferably linear. Specifically, —CF₂—, —CF₂CF₂—, or —CF(CF₃)— is preferred, —CF₂— or —CF₂CF₂— is more preferred, and —CF₂— is still more preferred.

In formula (A-2), R^{F3} is a perfluoroalkylene group having 1 to 6 carbon atoms and optionally having an etheric oxygen atom.

Specific examples of R^{F3} include —CF₂—, —CF₂CF₂—, —CF(CF₃)—, —CF₂CF₂CF₂—, —CF(CF₂CF₃)—, —CF(CF₃) CF₂—, —CF₂CF(CF₃)—, —C(CF₃)(CF₃)—, and —CF₂CF(CF₃)OCF₂CF(CF₃)—.

From the viewpoints of inexpensive raw materials, ease of production, and a further increase in the ion exchange capacity of polymer H, R^{F3} is preferably a perfluoroalkylene group having 1 to 3 carbon atoms. Specifically, —CF₂—, —CF₂CF₂—, or —CF₂CF(CF₃)— is preferred, and —CF₂CF(CF₃)— is more preferred.

In formula (A-2), m is 0 or 1.

From the viewpoint of providing good proton conductivity, the content of unit B relative to all units in polymer H is preferably 5 mol % or more, more preferably 10 mol % or more.

From the viewpoint of improving water repellency, increasing drainage properties, and improving power generation efficiency, the content of unit B relative to all units in polymer H is preferably 20 mol % or less, more preferably 17 mol % or less.

Polymer H may include only one type of unit B, or may include two or more types of unit B. When two or more types are included, the content means the total amount thereof.

Polymer H may include a tetrafluoroethylene (TFE) unit (hereinafter, also referred to as “unit C”).

The presence of unit C imparts water repellency, increases water discharge capability of the catalyst layer, and further improves power generation efficiency of a fuel cell.

When polymer H includes unit C, the content of unit C relative to all units in polymer H is preferably 5 mol % or more. From the viewpoint of improving dispersibility in a polymer solution, it is preferably 35 mol % or less.

As the units included in polymer H, the following configurations are preferred.
Configuration 1: Unit A, unit (A-1), (A-2), or (A-3), and unit C are included.
Configuration 2: Unit A and unit (A-1), (A-2), or (A-3) are included.
Configuration 3: Unit A and unit (u31) are included.

In each of the above preferred configurations, the total content of the units relative to all units in polymer H is preferably 95 mol % or more, more preferably 99 mol % or more, and is preferably 100 mol % or less. Specifically, in the case of configuration 1, the total content of unit A, unit (A-1), unit (A-2), unit (A-3), and unit C relative to all units in polymer H is preferably 95 mol % or more, more preferably 99 mol % or more, and is preferably 100 mol % or less.

From the viewpoint of more excellent power generation characteristics of a fuel cell, the softening temperature of polymer H is preferably 140° C. or higher, more preferably 150° C. or higher, still more preferably 160° C. or higher.

From the viewpoint of electrode durability, the softening temperature of polymer H is preferably 300° C. or lower, more preferably 250° C. or lower, still more preferably 200° C. or lower.

The softening temperature of polymer H is determined by a method described in EXAMPLES given below.

The content of polymer H relative to the total mass of the composition is preferably 1.0 mass % or more, more preferably 1.5 mass % or more, and is preferably 3.0 mass % or less, more preferably 2.5 mass % or less.

The present composition may include only one type of polymer H, or may include two or more types of polymer H. When two or more types are included, the content means the total amount thereof.

### (Method for Producing Polymer H)

A method for producing polymer H will be described by taking as an example a case where polymer H has an acid-form sulfonic acid group.

One example of the method for producing polymer H is to convert a precursor group of a precursor polymer (hereinafter, also referred to as “polymer F”), in which an acid-form sulfonic acid group in polymer H is a precursor group (specifically, a group represented by —SO₂F), into an acid-form sulfonic acid group (—SO₃⁻H⁺).

One specific example of the method for converting the group represented by —SO₂F, which is a precursor group, into an acid-form sulfonic acid group is to hydrolyze the group represented by —SO₂F of polymer F to be a salt-form sulfonate group, followed by converting the salt-form sulfonate group into an acid form to be an acid-form sulfonic acid group.

The TQ value of polymer F is preferably 300° C. or lower, more preferably 290° C. or lower, still more preferably 280° C. or lower. When the TQ value is equal to or less than the upper limit value, solubility or dispersibility of polymer H in a solvent is improved, and thus the composition is easily prepared.

The TQ value of polymer F is preferably 100° C. or higher, more preferably 130° C. or higher, still more preferably 160° C. or higher. When the TQ value is equal to or more than the lower limit value, polymer H having a sufficient molecular weight is obtained, and thus the catalyst layer has high strength.

The TQ value is a value related to the molecular weight of polymer F, and is expressed as the temperature at which a volumetric flow rate of 100 mm³/s is observed. The volumetric flow rate is the amount, expressed in units of mm³/s, of polymer F that flows out when polymer F is caused to melt and flow out from a nozzle (inner diameter: 1 mm, length: 1 mm) at a constant temperature under a pressure of 3 MPa. The TQ value is an indicator of the molecular weight of polymer F, and higher TQ values indicate higher molecular weights.

The TQ value of polymer F is determined by a method described in EXAMPLES given below.

### <Catalyst>

The present composition includes a catalyst.

The catalyst includes a carbon carrier (preferably a porous carbon carrier) and a metal supported on the carbon carrier.

The catalyst preferably has pore portions having a pore diameter of 2 nm or more and less than 10 nm. The pore portions are pores derived from the porous carrier constituting the catalyst. The catalyst may have pore portions having a pore diameter different from that of the pore portions having a pore diameter of 2 nm or more and less than 10 nm.

In the present specification, a pore distribution obtained by a nitrogen adsorption method is also referred to simply as a “pore distribution”. The pore diameter is determined from the pore distribution, and pores having a pore diameter of 50 nm or more and less than 300 nm are also referred to as “macropores”, pores having a pore diameter of 2 nm or more and less than 50 nm as “mesopores”, and pores having a pore diameter of 2 nm or more and less than 10 nm as “specific mesopores”.

The pore distribution can be measured, for example, by pore distribution measurement by a nitrogen adsorption method.

The total pore volume of the specific mesopores per gram of the catalyst is preferably 0.01 cm³ or more, more preferably 0.02 cm³ or more, from the viewpoint of initial performance, and is preferably 0.70 cm³ or less, more preferably 0.60 cm³ or less, still more preferably 0.40 cm³ or less, particularly preferably 0.20 cm³ or less, from the viewpoint of durability performance.

The total pore volume of the macropores per gram of the catalyst is preferably 0.05 cm³ or more, more preferably 0.10 cm³ or more, from the viewpoint of initial performance, and is preferably 0.70 cm³ or less, more preferably 0.60 cm³ or less, from the viewpoint of durability performance.

The proportion of the total pore volume of the specific mesopores in the total pore volume of the mesopores and the macropores is preferably 10% or more, more preferably 20% or more, from the viewpoint of initial performance, and is preferably 60% or less, more preferably 50% or less, from the viewpoint of durability performance.

The total pore volume of each type of pores can be measured, for example, by pore distribution measurement by a nitrogen adsorption method.

From the viewpoint of further suppressing the occurrence of cracking of the catalyst layer, the specific surface area of the catalyst is preferably 500 m²/g or more, more preferably 700 m²/g or more, still more preferably 800 m²/g or more.

From the viewpoint of oxidation durability performance of a polymer electrolyte fuel cell, the specific surface area of the catalyst is preferably 1,600 m²/g or less, more preferably 1,500 m²/g or less, still more preferably 1,400 m²/g or less.

The specific surface area of the catalyst is determined in the same manner as the specific surface area of a carbon carrier described below.

The catalyst includes a carbon carrier.

Specific examples of the carbon carrier (preferably the porous carrier) include carbon black powder, graphitized carbon, carbon fibers, and carbon nanotubes.

The shape of the carbon carrier (preferably the porous carbon carrier) is not particularly limited.

The average particle size of primary particles of the carbon carrier is not particularly limited as long as the metal can be supported, and the average particle size of primary particles of the carbon carrier is preferably 30 nm or more, more preferably 50 nm or more, and is preferably 300 nm or less, more preferably 200 nm or less.

The average particle size of primary particles of the carbon carrier means an arithmetic mean of measured particle sizes (diameters) of randomly selected 100 primary particles of the carbon carrier observed with a TEM (transmission electron microscope). When the shape of particles observed is not spherical, the diameter is measured assuming the particles to be spherical.

The specific surface area of the carbon carrier (per gram of the carbon carrier) is preferably 140 m²/g or more, more preferably 150 m²/g or more, still more preferably 300 m²/g or more, yet more preferably 500 m²/g or more, particularly preferably 700 m²/g or more, most preferably 800 m²/g or more.

From the viewpoint of oxidation durability performance of a polymer electrolyte fuel cell, the specific surface area of the carbon carrier (per gram of the carbon carrier) is preferably 1,400 m²/g or less, more preferably 1,330 m²/g or less, still more preferably 1,300 m²/g or less, particularly preferably 1,200 m²/g or less. The specific surface area of the carbon carrier is also preferably 140 to 1,400 m²/g, more preferably 150 to 900 m²/g, still more preferably 500 to 900 m²/g.

The specific surface area of the carbon carrier is determined by a method described in EXAMPLES given below.

The content of the carbon carrier relative to the total mass of the catalyst is preferably 30 mass % or more, more preferably 40 mass % or more.

The content of the carbon carrier relative to the total mass of the catalyst is preferably 80 mass % or less, more preferably 70 mass % or less.

The catalyst includes a metal supported on the carbon carrier.

Specific examples of the metal include platinum and a platinum alloy.

The platinum alloy is preferably an alloy of platinum and at least one metal selected from the group consisting of platinum group metals other than platinum (ruthenium, rhodium, palladium, osmium, and iridium), gold, silver, chromium, iron, titanium, manganese, cobalt, nickel, molybdenum, tungsten, aluminum, silicon, zinc, and tin, more preferably an alloy of platinum and cobalt.

The shape of the metal supported on the carbon carrier is not particularly limited, and is preferably particulate.

The average particle size (number average particle size D50) of the metal supported on the carbon carrier is not particularly limited as long as its performance can be exhibited, and is preferably 1 nm or more, more preferably 2 nm or more, and is preferably 10 nm or less, more preferably 5 nm or less.

The average particle size of the metal is measured with a TEM (transmission electron microscope) or by SAXS (small-angle X-ray scattering).

From the viewpoint of higher power generation efficiency of a fuel cell, the amount of the metal supported is preferably 20 mass % or more, more preferably 30 mass % or more, relative to the total mass of the catalyst.

From the viewpoint of power generation efficiency of a fuel cell, the amount of the metal supported is preferably 70 mass % or less, more preferably 60 mass % or less, relative to the total mass of the catalyst.

The content of the catalyst relative to the total mass of the composition is preferably 3.0 mass % or more, more preferably 4.0 mass % or more, and is preferably 7.0 mass % or less, more preferably 6.0 mass % or less.

The present composition may include only one type of catalyst, or may include two or more types of catalysts. When two or more types are included, the content means the total amount thereof.

### <Solvent>

The present composition includes a solvent.

The solvent preferably includes water and an alcohol.

Specific examples of the alcohol include methanol, ethanol, propanol (specifically, 1-propanol and 2-propanol), 1-butanol, 2-methyl-1-propanol, 2-butanol, 2-methyl-2-propanol, 2,2,2-trifluoroethanol, 2,2,3,3,3-pentafluoro-1-propanol, 2,2,3,3-tetrafluoro-1-propanol, 4,4,5,5,5-pentafluoro-1-pentanol, 1,1,1,3,3,3-hexafluoro-2-propanol, 3,3,3-trifluoro-1-propanol, 3,3,4,4,5,5,6,6,6-nonafluoro-1-hexanol, and 3,3,4,4,5,5,6,6,7,7,8,8,8-tridecafluoro-1-octanol.

The alcohol is preferably ethanol or propanol.

The content of water in the solvent relative to the total mass of the solvent is preferably 50 mass % or more, more preferably 55 mass % or more, still more preferably 60 mass % or more, and is preferably 90 mass % or less, more preferably less than 80 mass %, still more preferably 70 mass % or less. When the content of water in the solvent is within the above range, the occurrence of cracking of the catalyst layer can be further suppressed.

The content of water in the present composition relative to the total mass of the present composition is preferably 40 mass % or more, more preferably 45 mass % or more, still more preferably 50 mass % or more, from the viewpoint of suppressing cracking of the catalyst layer, and is preferably 70 mass % or less, more preferably 65 mass % or less, still more preferably 60 mass % or less, from the viewpoint of stability of the present composition.

The content of the alcohol in the present composition relative to the total mass of the present composition is preferably 20 mass % or more, more preferably 30 mass % or more, still more preferably 35 mass % or more, from the viewpoint of suppressing the occurrence of cracking of the catalyst layer, and is preferably 60 mass % or less, more preferably 50 mass % or less, still more preferably 40 mass % or less, from the viewpoint of stability of the present composition.

In the present composition, the mass ratio of the content of the alcohol to the content of water (content of alcohol/content of water) is preferably 0.60 or more, more preferably 0.65 or more, and is preferably 0.80 or less, more preferably 0.70 or less.

### [Catalyst Layer]

A catalyst layer according to the present invention includes a fluorinated polymer that has a unit having a cyclic ether structure and has an ion exchange group, and a catalyst, wherein the fluorinated polymer has an ion exchange capacity of 1.20 meq/g dry resin or less, the catalyst includes a carbon carrier and a metal supported on the carbon carrier, and the ratio of the mass of the fluorinated polymer to the mass of the carbon carrier is 0.6 to 1.5.

The catalyst layer according to the present invention is preferably a catalyst layer formed using the present composition.

Various components that can be contained in the catalyst layer according to the present invention include various components other than the solvent that can be contained in the present composition described above, and preferred embodiments thereof are also the same.

The content of polymer H relative to the total mass of the catalyst layer is preferably 20 mass % or more, more preferably 25 mass % or more, and is preferably 40 mass % or less, more preferably 30 mass % or less.

The content of the catalyst relative to the total mass of the catalyst layer is preferably 60 mass % or more, more preferably 65 mass % or more, and is preferably 80 mass % or less, more preferably 75 mass % or less.

The method for producing the catalyst layer is preferably a method for producing a catalyst layer in a membrane electrode assembly described below.

### [Membrane Electrode Assembly]

A membrane electrode assembly according to the present invention includes an anode having a first catalyst layer, a cathode having a second catalyst layer, and a polymer electrolyte membrane disposed between the anode and the cathode. The membrane electrode assembly is suitably used for a polymer electrolyte fuel cell.

The present composition described above may be used for forming either the catalyst layer of the anode or the catalyst layer of the cathode, and is preferably used for forming the catalyst layer of the cathode from the viewpoint of being effective in providing a higher current output. In other words, the present composition is preferably a composition for forming a cathode catalyst layer.

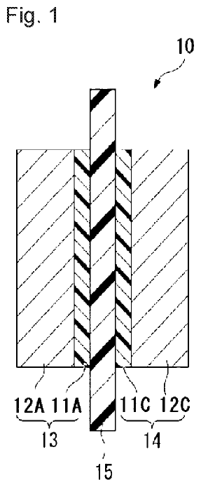

FIG. 1 is a sectional view illustrating an example of the membrane electrode assembly according to the present invention. A membrane electrode assembly 10 includes an anode 13 having a catalyst layer 11A and a gas diffusion layer 12A, a cathode 14 having a catalyst layer 11C and a gas diffusion layer 12C, and a polymer electrolyte membrane 15 disposed between the anode 13 and the cathode 14 in contact with the catalyst layer 11A and the catalyst layer 11C.

Examples of the method for forming the catalyst layer 11C include, but are not limited to, the following methods.
(i) A method in which the present composition is applied onto the polymer electrolyte membrane 15 or the gas diffusion layer 12C and dried.
(ii) A method in which the present composition is applied onto a substrate film and dried to form the catalyst layer 11C, and the catalyst layer 11C is transferred onto the polymer electrolyte membrane 15.

The gas diffusion layer 12C has a function to uniformly diffuse gas to the catalyst layer 11C and a function as a current collector.

Examples of the gas diffusion layer 12C include carbon paper, carbon cloth, and carbon felt. The gas diffusion layer 12C is preferably treated with polytetrafluoroethylene or the like to be water-repellent.

Although the gas diffusion layer 12C is included in the membrane electrode assembly 10 in FIG. 1, the gas diffusion layer is an optional member and may not be included in the membrane electrode assembly.

The catalyst layer 11A included in the anode 13 may be a known catalyst layer for an anode, and can be produced in the same manner as the known catalyst layer for an anode.

Specific examples of the gas diffusion layer 12A included in the anode 13 are the same as the specific examples of the gas diffusion layer 12C described above, and the gas diffusion layer 12A is an optional member as with the gas diffusion layer 12C.

The polymer electrolyte membrane 15 is a membrane including a polymer having an ion exchange group.

Examples of the polymer having an ion exchange group include polymer H described above and known polymers having an ion exchange group.

Specific examples of known polymers include a polymer obtained by converting a group represented by —SO₂F of a polymer having a unit based on monomer (m31) and a unit based on tetrafluoroethylene into a sulfonic acid group, as described in International Publication No. 2020/145287, and a polymer obtained by converting a group represented by —SO₂F of a polymer having a unit based on monomer (m32) and a unit based on tetrafluoroethylene into a sulfonic acid group, as described in International Publication No. 2020/145287.

The polymer electrolyte membrane 15 can be formed, for example, by a method (casting method) in which a liquid composition of a polymer is applied onto a substrate film or a catalyst layer (the catalyst layer 11A or the catalyst layer 11C) and dried.

The liquid composition is a dispersion liquid in which the polymer is dispersed in a solvent including at least one of an organic solvent and water.

In order to stabilize the polymer electrolyte membrane 15, heat treatment is preferably performed. The heat treatment temperature varies depending on the type of polymer, and is preferably 130° C. to 200° C.

The polymer electrolyte membrane 15 may be treated with a hydrogen peroxide solution as necessary.

The polymer electrolyte membrane 15 may be reinforced with a reinforcing material. Examples of the reinforcing material include porous bodies, fibers, woven fabric, and nonwoven fabric. Examples of the material of the reinforcing material include polytetrafluoroethylene, tetrafluoroethylene-hexafluoropropylene copolymers, tetrafluoroethylene-perfluoro (alkyl vinyl ether) copolymers, polyethylene, polypropylene, and polyphenylene sulfide.

The polymer electrolyte membrane 15 may include one or more atoms selected from the group consisting of cerium and manganese in order to further improve durability. Cerium and manganese decompose hydrogen peroxide, which is a substance that causes deterioration of the polymer electrolyte membrane 15. Cerium and manganese are preferably present in the polymer electrolyte membrane 15 in the form of ions, and may be present in any state in the polymer electrolyte membrane 15 as long as they are present in the form of ions.

The polymer electrolyte membrane 15 may include silica or a heteropolyacid (zirconium phosphate, phosphomolybdic acid, phosphotungstic acid, or the like) as a water retention agent for preventing drying.

The membrane electrode assembly 10 is produced, for example, by the following methods.
(i) A method in which catalyst layers (the catalyst layer 11A and the catalyst layer 11C) are formed on the polymer electrolyte membrane 15 to obtain a membrane catalyst layer assembly, and the membrane catalyst layer assembly is sandwiched between gas diffusion layers (the gas diffusion layer 12A and the gas diffusion layer 12C).
(ii) A method in which catalyst layers (the catalyst layer 11A and the catalyst layer 11C) are formed on gas diffusion layers (the gas diffusion layer 12A and the gas diffusion layer 12C) to obtain electrodes (the anode 13 and the cathode 14), and the polymer electrolyte membrane 15 is sandwiched between the electrodes.

The membrane electrode assembly 10 may include a carbon layer (not illustrated) between the catalyst layer and the gas diffusion layer. By disposing the carbon layer, gas diffusibility on a surface of the catalyst layer 11 is improved, and power generation performance of a fuel cell can be further improved.

The carbon layer includes, for example, carbon and a nonionic fluorinated polymer. Specifically, for example, the carbon is preferably a carbon nanofiber having a fiber diameter of 1 to 1,000 nm and a fiber length of 1,000 μm or less. One specific example of the nonionic fluorinated polymer is polytetrafluoroethylene.

### [Polymer Electrolyte Fuel Cell]

A polymer electrolyte fuel cell according to the present invention includes the membrane electrode assembly described above.

The polymer electrolyte fuel cell according to the present invention may include, on both surfaces of the membrane electrode assembly, separators in which grooves serving as gas flow paths are formed.

Specific examples of the separators include metal separators, carbon separators, separators made of materials obtained by mixing graphite and resin, and separators made of various conductive materials.

In the polymer electrolyte fuel cell, power is generated by supplying a gas containing oxygen to the cathode and supplying a gas containing hydrogen to the anode.

The membrane electrode assembly described above can be applied also to a methanol fuel cell that generates power by supplying methanol to the anode.

### EXAMPLES

The present invention will be described in detail below with reference to examples. Examples 1 to 7 are Examples of the present invention, and Example 8 to 13 are Comparative Examples.

However, the present invention is not limited to these examples. The amounts of components in the table given later are by mass.

### [Measurement Method]

<Ion exchange Capacity>

At 4 MPa (gauge pressure), polymers F-1 to F-7 were each press-molded at 210° C., and polymers F-8 and F-9 were each press-molded at a temperature 10° C. higher than their TQ value, thereby obtaining membranes of polymers F-1 to F-9 (100 to 250 μm thick). The membranes of polymers F-1 to F-9 were each immersed in an alkaline aqueous solution shown in Table 2 at 80° C. for 16 hours to hydrolyze —SO₂F of polymers F-1 to F-9 into —SO₃K. Each polymer membrane was further immersed in a 3 mol/L aqueous hydrochloric acid solution at 50° C. for 30 minutes and then immersed in ultrapure water at 80° C. for 30 minutes. The cycle of immersion in the aqueous hydrochloric acid solution and immersion in ultrapure water was performed a total of five times to convert —SO₃K of each polymer into —SO₃H. Washing with ultrapure water was repeated until the pH of water in which each polymer membrane was immersed reached 7. The polymer membranes were each air-dried while being sandwiched between filter papers to obtain membranes of polymer H-1 to polymer H-9.

Each polymer H membrane obtained was dried in a glove box under nitrogen flow until no further mass change was observed, and the mass was determined, after which the polymer H membrane was immersed in a 0.85 mol/g sodium hydroxide solution (solvent: water/methanol=10/90 (mass ratio)) at 60° C. for 72 hours or more to convert the acid-form sulfonic acid group into a sodium salt-form sulfonate group. The ion exchange capacity of polymer H was determined by back titration of the amount of remaining sodium hydroxide with 0.1 mol/L hydrochloric acid.

### <¹⁹F-NMR>

¹⁹F-NMR was measured under conditions of frequency: 282.7 MHz and chemical shift reference: CFCl₃. Composition analysis of polymer F was performed by using hexafluorobenzene as a dissolution solvent and adjusting the solution concentration to 10 mass %.

### <Ratio of Units>

The ratio of units in a polymer derived from monomer units was calculated from measured values of ¹⁹F-NMR. The contents of units in polymer H are substantially equal to the contents of the units in polymer F.

### <TQ Value>

Using a flow tester (CFT-500A manufactured by Shimadzu Corporation) equipped with a nozzle having a length of 1 mm and an inner diameter of 1 mm, polymer F was melt-extruded at an extrusion pressure of 2.94 MPa (gauge pressure) while the temperature was varied. The temperature (TQ value) at which the extrusion rate of polymer F was 100 mm³/s was determined. When the TQ value exceeded 300° C., four extrusion rates at 300° C. or lower were determined, and the TQ value was determined by extrapolation from the four measured values. The extrapolation was performed using an approximate expression obtained by logarithmically approximating the correlation between the extrusion rate and the reciprocal of the absolute temperature. For polymers having the same composition, a polymer having a higher TQ value has a larger molecular weight.

### <Softening Temperature>

The softening temperature of polymer H was measured by the following method.

Liquid composition S (liquid compositions S-1 to S-9 described later) in which polymer H was dispersed in a mixed solvent was cast on a Petri dish and then annealed to produce a polymer electrolyte membrane. Dynamic viscoelasticity measurement was performed on the polymer electrolyte membrane using a dynamic viscoelasticity measuring apparatus (DVA-225 manufactured by IT Keisoku Seigyo Co., Ltd.) under conditions of sample width: 5.0 mm, grip-to-grip distance: 15 mm, measurement frequency: 1 Hz, temperature rising rate: 2° C./min, and tensile mode. From the ratio (E″/E′) of a loss modulus E″ to a storage modulus E′, tan δ (loss tangent) was calculated, and a tan δ-temperature curve was prepared. From the tan δ-temperature curve, a peak temperature between −100° C. and 200° C. was read, and this value was determined as the softening temperature of polymer H. The softening temperature corresponds to a temperature at which a transition from a glassy state to a rubbery state occurs. The basic dimensions and thickness of the membrane used for the calculation were measured under conditions of temperature: 23° C. and relative humidity: 50% RH.

### ABBREVIATIONS

TFE: tetrafluoroethylene
PFB: CF₃CF₂CF₂C(O)OOC(O)CF₂CF₂CF₃
HFC-52-13p: CF₃(CF₂)₅H
HFE-347pc-f: CF₃CH₂OCF₂CF₂H
HCFC-225cb: CClF₂CF₂CHClF
V601: CH₃O—C(═O)—C(CH₃)₂—N═N—C(CH₃)₂—C(═O)—OCH₃

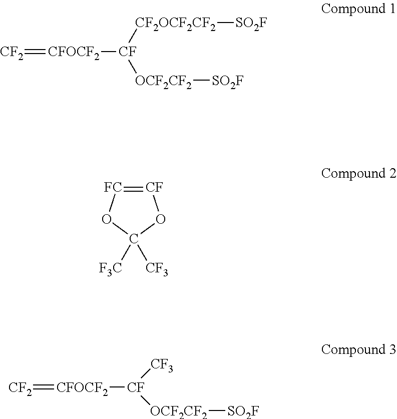

### [Synthesis of Polymer F]

### <Synthesis of Polymer F-1>

A stainless-steel autoclave having an internal capacity of 2,575 mL was depressurized in an ice bath, 1116.02 g of compound 1, 340.92 g of compound 2, 407.78 mg of PFB dissolved in HFC-52-13p at a concentration of 3.2 mass %, and 172.0 g of HFC-52-13p were drawn into the autoclave, and the autoclave was depressurized again. Thereafter, 56.90 g of TFE was charged, and the temperature was raised to 24° C. to start a reaction. Stirring during the reaction was performed with a double helical ribbon impeller, and the stirring rotation speed was set to 60 rpm for a period from the start of the reaction to 2.5 hours, 30 rpm for a period from 2.5 hours to 3.5 hours, and 10 rpm for a period from 3.5 hours to 10 hours. After stirring for 10 hours, the autoclave was depressurized, and unreacted compound 2 and TFE were distilled off. Thereafter, the product was diluted with HFC-52-13p and then mixed with a mixed solution of HFC-52-13p:methanol=8:2 (mass ratio), and a polymer was coagulated and filtered. The polymer was washed in a mixed solution of HFC-52-13p:methanol=7:3 (mass ratio) and separated by filtration, and then solids were dried at 80° C. and then vacuum-dried at 210° C. to obtain polymer F-1.

### <Synthesis of Polymer F-2>

In a stainless-steel autoclave having an internal capacity of 230 mL, 129.48 g of compound 1, 39.91 g of compound 2, 9.80 g of HFE-347pc-f, and 90.63 mg of PFB dissolved in HFE-347pc-f at a concentration of 3.26 mass % were charged, and sufficiently degassed under cooling with liquid nitrogen. Thereafter, 5.46 g of TFE was charged, and the temperature was raised to 24° C. to start a reaction. Stirring during the reaction was performed with an anchor impeller, and the stirring rotation speed was set to 100 rpm. After stirring for 5.5 hours, the autoclave was cooled to terminate the reaction. The product was diluted with HFC-52-13p and then mixed with a mixed solution of HFC-52-13p:methanol=8:2 (mass ratio), and a polymer was coagulated and filtered. The polymer was washed in a mixed solution of HFC-52-13p:methanol=7:3 (mass ratio) and separated by filtration, and then solids were dried under reduced pressure at 210° C. overnight to obtain polymer F-2.

### <Synthesis of Polymer F-3>

In a stainless-steel autoclave having an internal capacity of 230 mL, 92.62 g of compound 1, 34.08 g of compound 2, 44.92 g of HFE-347pc-f, and 93.64 mg of PFB dissolved in HFE-347pc-f at a concentration of 3.05 mass % were charged, and sufficiently degassed under cooling with liquid nitrogen. Thereafter, 4.19 g of TFE was charged, and the temperature was raised to 24° C. to start a reaction. Stirring during the reaction was performed with an anchor impeller, and the stirring rotation speed was set to 100 rpm. After stirring for 7 hours, the autoclave was cooled to terminate the reaction. The product was diluted with HFC-52-13p and then mixed with a mixed solution of HFC-52-13p:methanol=8:2 (mass ratio), and a polymer was coagulated and filtered. The polymer was washed in a mixed solution of HFC-52-13p:methanol=7:3 (mass ratio) and separated by filtration, and then solids were dried under reduced pressure at 210° C. overnight to obtain polymer F-3.

### <Synthesis of Polymer F-4>

In a stainless-steel autoclave having an internal capacity of 230 mL, 30.55 g of compound 2, 151.05 g of compound 3, 0.55 g of HFE-347pc-f, and 54.56 mg of PFB dissolved in HFE-347pc-f at a concentration of 3.05 mass % were charged, and after sufficient degassing under cooling with liquid nitrogen, the temperature was raised to 20° C. to start a reaction. After stirring for 24 hours, the autoclave was cooled to terminate the reaction. The product was diluted with HFC-52-13p and HFE-347pc-f and then mixed with a mixed solution of HFE-347pc-f:methanol=5:5 (mass ratio), and a polymer was coagulated and filtered. The polymer was washed in a mixed solution of HFE-347pc-f:methanol=5:5 (mass ratio) and separated by filtration, and then solids were dried under reduced pressure at 210° C. overnight to obtain polymer F-4.

### <Synthesis of Polymer F-5>

In a stainless-steel autoclave having an internal capacity of 230 mL, 63.89 g of compound 2, 134.39 g of compound 3, 0.45 g of HFE-347pc-f, and 59.9 mg of PFB dissolved in HFE-347pc-f at a concentration of 2.51 mass % were charged, and after sufficient degassing under cooling with liquid nitrogen, the temperature was raised to 20° C. to start a reaction. After stirring for 24 hours, the autoclave was cooled to terminate the reaction. The product was diluted with HFC-52-13p and HFE-347pc-f and then mixed with a mixed solution of HFE-347pc-f:methanol=8:2 (mass ratio), and a polymer was coagulated and filtered. The polymer was washed in a mixed solution of HFE-347pc-f:methanol=5:5 (mass ratio) and separated by filtration, and then solids were dried under reduced pressure at 210° C. overnight to obtain polymer F-5.

### <Synthesis of Polymer F-6>

In a stainless-steel autoclave having an internal capacity of 230 mL, 133.16 g of compound 2, 32.67 g of compound 1, and 14.1 g of HFC-52-13p were charged, and sufficiently degassed under cooling with liquid nitrogen. TFE in an amount of 3.94 g was charged, the temperature was raised to 24° C., 40.17 mg of PFB dissolved in HFE-347pc-f at a concentration of 2.8 mass % was charged, a charging line was washed with 1.1 g of HCFC-225cb, and a reaction was started. After stirring for 8 hours, the autoclave was cooled to terminate the reaction. The product was diluted with HFC-52-13p and then mixed with a mixed solution of HFC-52-13p:methanol=8:2 (mass ratio), and a polymer was coagulated and filtered. The polymer was washed in a mixed solution of HFC-52-13p:methanol=7:3 (mass ratio) and separated by filtration, and then solids were dried under reduced pressure at 80° C. overnight to obtain polymer F-6.

### <Synthesis of Polymer F-7>

In a stainless-steel autoclave having an internal capacity of 230 mL, 115.51 g of compound 1, 24.29 g of compound 2, 43.68 mg of PFB dissolved in HFE-347pc-f at a concentration of 3.26 mass %, and 2.54 g of HFE-347pc-f were charged, and sufficiently degassed under cooling with liquid nitrogen. Thereafter, 2.40 g of TFE was charged, and the temperature was raised to 24° C. to start a reaction. Stirring during the reaction was performed with an anchor impeller, and the stirring rotation speed was set to 100 rpm for a period from the start of the reaction to 2.5 hours, and 50 rpm for a period from 2.5 hours to 18 hours. After stirring for 18 hours, the autoclave was depressurized, and unreacted compound 2 and TFE were distilled off. The product was diluted with HFE-347pc-f and then mixed with a mixed solution of HFE-347pc-f:methanol=85:15 (mass ratio), and a polymer was coagulated and filtered. The polymer was washed in a mixed solution of HFE-347pc-f:methanol=50:50 (mass ratio) and separated by filtration, and then solids were dried at 80° C. and then vacuum-dried at 210° C. to obtain polymer F-7.

### <Synthesis of Polymer F-8>

In an autoclave (internal capacity 230 mL, made of Hastelloy), 123.8 g of compound 3, 35.2 g of HCFC-225cb as a solvent, and 63.62 mg of 2,2′-azobis(isobutyronitrile) as an initiator were charged, and degassed under cooling with liquid nitrogen. Thereafter, the temperature was raised to 70° C., TFE was introduced into the system, and the pressure was maintained at 1.14 MPaG. Polymerization was performed while TFE was continuously added so as to keep the pressure at 1.14 MPaG. When the amount of TFE added reached 12.4 g after 7.9 hours, the autoclave was cooled, and the gas in the system was purged to terminate the polymerization.

The obtained polymer solution was diluted with HCFC-225cb, and then coagulated with HCFC-141b added. After washing was performed using HCFC-225cb and HCFC-141b, drying was performed to obtain 25.1 g of polymer F-8 consisting of a TFE/compound 3 copolymer.

### <Synthesis of Polymer F-9>

A stainless-steel autoclave having an internal capacity of 1006 mL was depressurized in an ice bath, 798.33 g of compound 1 and 0.1353 g of V601 dissolved in 7.97 g of HFC-52-13p were drawn into the autoclave, and the autoclave was depressurized again. Thereafter, 71.9 g of TFE was charged, and the temperature was raised to 57° C. The pressure at this time was 0.830 MPa (gauge pressure).

Thereafter, N₂ was introduced until 0.950 MPa (gauge pressure) was reached, and a reaction was started. Stirring during the reaction was performed with a double helical ribbon impeller, and the stirring rotation speed was set to 230 rpm. During the reaction, TFE was continuously added so as to maintain the pressure at 0.950 MPa (gauge pressure). After 18 hours elapsed, the autoclave was cooled to an internal temperature of 20° C. or lower, and then the gas in the autoclave was purged. The amount of TFE additionally added was 50.3 g. The reaction solution was diluted with 390.6 g of HFC-52-13p and then mixed with 3007 g of cooled HFE-347pc-f, and a polymer was coagulated and filtered. At this time, the temperature of the reaction solution was 19° C., and the temperature of the cooled HFE-347pc-f was −5° C. Thereafter, the polymer was washed with 752 g of HFE-347pc-f and separated by filtration, and then solids were dried at 80° C. and then vacuum-dried at 240° C. to obtain polymer F-9.

The composition and TQ value of polymers F-1 to F-9 are shown in the following table.

TABLE 1

| Type of polymer F | F-1 | F-2 | F-3 | F-4 | F-5 | F-6 | F-7 | F-8 | F-9 |
|---|---|---|---|---|---|---|---|---|---|
| Compound 1 unit [mol %] | 15 | 14 | 12 | 0 | 0 | 18 | 22 | 0 | 19 |
| Compound 2 unit | 60 | 62 | 63 | 65 | 68 | 66 | 63 | 0 | 0 |
| (cyclic ether structure unit) | | | | | | | | | |
| [mol %] | | | | | | | | | |
| Compound 3 unit [mol %] | 0 | 0 | 0 | 35 | 32 | 0 | 0 | 18 | 0 |
| TFE unit [mol %] | 25 | 24 | 25 | 0 | 0 | 16 | 15 | 82 | 81 |
| TQ value [° C.] | 290 | 279 | 277 | 239 | 330 | 275 | 238 | 225 | 239 |

### [Synthesis of Polymer H]

Using polymers F, powders of polymers H-1 to H-9 were obtained by the following method.

Each polymer F was cooled with dry ice and then pulverized. The pulverized polymer F was immersed in an alkaline aqueous solution shown in Table 2 at 80° C. for 40 hours to hydrolyze —SO₂F of polymer F into —SO₃K. The obtained polymer was further immersed in a 3 mol/L aqueous hydrochloric acid solution at 80° C. for 30 minutes and then immersed in ultrapure water at 80° C. for 30 minutes. The cycle of immersion in the aqueous hydrochloric acid solution and immersion in ultrapure water was performed a total of ten times to convert —SO₃K of the polymer into —SO₃H. Washing with ultrapure water was repeated until the pH of water in which the polymer was immersed reached 7. Drying was performed under nitrogen flow to obtain a powder of polymer H. The results are shown in Table 2.

The ion exchange capacity and softening temperature of polymer H are values measured by the methods described above.

In Table 2, aqueous solution A is potassium hydroxide/dimethyl sulfoxide/water=15/30/55 (mass ratio), and aqueous solution B is potassium hydroxide/methanol/water=15/20/65 (mass ratio).

TABLE 2

| Polymer F used | | F-1 | F-2 | F-3 | F-4 | F-5 | F-6 | F-7 | F-8 | F-9 |
|---|---|---|---|---|---|---|---|---|---|---|
| Alkaline aqueous solution | | Aqueous | Aqueous | Aqueous | Aqueous | Aqueous | Aqueous | Aqueous | Aqueous | Aqueous |
| | | solution A | solution A | solution A | solution B | solution A | solution A | solution B | solution B | solution B |
| Polymer H | Type | H-1 | H-2 | H-3 | H-4 | H-5 | H-6 | H-7 | H-8 | H-9 |
| | Ion exchange capacity | 1.09 | 1.00 | 0.91 | 1.07 | 0.98 | 1.23 | 1.42 | 1.10 | 1.95 |
| | [meq/g dry resin] | | | | | | | | | |
| | Softening temperature [° C.] | 172 | 174 | 175 | 189 | 250 | 176 | 178 | 105 | 130 |

### [Preparation of Liquid Composition]

### <Liquid Composition S-1>

To a 0.2 L glass autoclave, 18.70 g of a polymer (powder) (breakdown: 18.22 g of polymer H-1 and 0.48 g of water, solids concentration 97.4 mass %), 22.81 g of ultrapure water, and 54.36 g of 1-propanol were added, and the mixture was stirred at 115° C. for 13 hours at 300 rpm and then diluted with 31.0 g of ultrapure water. The resultant was stirred at 110° C. for 1 hour and then allowed to cool, and a solution was taken out from the autoclave. This solution was diluted with 25.6 g of ultrapure water and 25.6 g of 1-propanol, and the resultant was stirred at 110° C. for 1 hour, then allowed to cool, and filtered using a pressure filtration machine (filter paper: PF040 manufactured by Advantec Toyo Kaisha, Ltd.), thereby obtaining liquid composition S-1 in which polymer H-1 was dispersed in a mixed solvent at 10.2 mass %.

### <Liquid Composition S-2>

To a 0.2 L glass autoclave, 20.00 g of a polymer (powder) (breakdown: 19.50 g of polymer H-2 and 0.50 g of water), 22.90 g of ultrapure water, and 54.60 g of 1-propanol were added, and the mixture was stirred at 115° C. for 6 hours at 300 rpm and then diluted with 31.2 g of ultrapure water. The resultant was stirred at 110° C. for 1 hour and then allowed to cool, and a solution was taken out from the autoclave. The solution was filtered using a pressure filtration machine (filter paper: PF040 manufactured by Advantec Toyo Kaisha, Ltd.), thereby obtaining liquid composition S-2 in which polymer H-2 was dispersed in a mixed solvent at 15.2 mass %.

### <Liquid Composition S-3>

To a 0.2 L glass autoclave, polymer H-3 (powder), ultrapure water, and 1-propanol were added, and the mixture was stirred at 115° C. for 6 hours at 300 rpm and then diluted with ultrapure water. The resultant was stirred at 110° C. for 1 hour and then allowed to cool, and a solution was taken out from the autoclave. The solution was filtered using a pressure filtration machine (filter paper: PF040 manufactured by Advantec Toyo Kaisha, Ltd.), thereby obtaining liquid composition S-3 in which polymer H-3 was dispersed in a mixed solvent at 13.0 mass %.

### <Liquid Composition S-4>

To a 0.2 L glass autoclave, 17.60 g of a polymer (powder) (breakdown: 17.60 g consisted of 17.09 g of polymer H-4 and 0.51 g of water), 17.19 g of ultrapure water, and 41.2 g of 1-propanol were added, and the mixture was stirred at 105° C. for 6 hours at 300 rpm and then allowed to cool, and a solution was taken out from the autoclave. The solution was filtered using a pressure filtration machine (filter paper: PF040 manufactured by Advantec Toyo Kaisha, Ltd.), thereby obtaining liquid composition S-4 in which polymer H-4 was dispersed in a mixed solvent at 23.0 mass %.

### <Liquid Composition S-5>

To a 0.2 L glass autoclave, 15.01 g of a polymer (powder) (breakdown: 14.78 g of polymer H-5 and 0.23 g of water, solids concentration 98.44 mass %), 61.20 g of ultrapure water, and 9.40 g of 1-propanol were added, and the mixture was stirred at 115° C. for 6 hours at 300 rpm. After cooling and stirring at 43° C. for 7 hours at 300 rpm, the mixture was diluted with 10.00 g of ultrapure water. The resultant was stirred at 80° C. for 1 hour at 150 rpm and then allowed to cool, and a solution was taken out from the autoclave. The solution was filtered using a pressure filtration machine (filter paper: PF040 manufactured by Advantec Toyo Kaisha, Ltd.), thereby obtaining liquid composition S-5 in which polymer H-5 was dispersed in a mixed solvent at 10.3 mass %.

### <Liquid Composition S-6>

To a 0.2 L glass autoclave, 12.13 g of polymer H-6, 15.5 g of ultrapure water, and 36.2 g of 1-propanol were added, and the mixture was stirred at 110° C. for 6 hours at 300 rpm and then diluted with 31.0 g of ultrapure water and 10.0 g of 1-propanol. The resultant was stirred at 110° C. for 1 hour and then allowed to cool, and a solution was taken out from the autoclave. The solution was filtered using a pressure filtration machine (filter paper: PF040 manufactured by Advantec Toyo Kaisha, Ltd.), thereby obtaining 104.8 g of liquid composition S-6 in which polymer H-6 was dispersed in a mixed solvent at 11.6 mass %.

### <Liquid Composition S-7>

To a 0.2 L glass autoclave, 23.02 g of a polymer (breakdown: 23.02 g consisted of 21.08 g of polymer H-7 and 1.94 g of water), 19.23 g of ultrapure water, and 49.40 g of 1-propanol were added, and the mixture was stirred at 115° C. for 6 hours at 300 rpm and then diluted with 43.57 g of ultrapure water and 15.34 g of 1-propanol. The resultant was stirred at 110° C. for 1 hour and then allowed to cool, and a solution was taken out from the autoclave. The solution was filtered using a pressure filtration machine (filter paper: TCP-10V), thereby obtaining 150.6 g of liquid composition S-7 in which polymer H-7 was dispersed in a mixed solvent at 14.0 mass %.

### <Liquid Composition S-8>

Using polymer F-8 as a raw material, liquid composition S-8 in which polymer H-8 was dispersed (solids concentration=26.0 mass %, ethanol/water=60/40 (mass ratio)) was obtained by the method described in Production Example 4 of JP-A-2018-55877.

### <Liquid Composition S-9>

To a 0.2 L glass autoclave, 24.02 g of a polymer (breakdown: 24.02 g consisted of 23.28 g of polymer H-9 and 0.74 g of water), 38.26 g of ultrapure water, and 38.97 g of ethanol were added, and the mixture was stirred at 110° C. for 6 hours at 300 rpm and then diluted with 53.22 g of ultrapure water and 0.57 g of ethanol. The resultant was stirred at 110° C. for 1 hour and then allowed to cool, and a solution was taken out from the autoclave. The solution was filtered using a pressure filtration machine (filter paper: PF040 manufactured by Advantec Toyo Kaisha, Ltd.), thereby obtaining 155.2 g of liquid composition S-9 in which polymer H-9 was dispersed in a mixed solvent at 15.0 mass %.

### [Preparation of Cathode Catalyst Layer-Forming Composition]

### <Catalyst>

Catalysts 1 to 3 were provided as catalysts.

### (Catalyst 1)

Type of metal: platinum particles
Number average particle size of platinum particles: 2.4 nm
Content of platinum particles relative to total mass of catalyst: 46.9 mass %
Content of carbon carrier relative to total mass of catalyst: 53.1 mass %
Type of porous carrier: carbon carrier (carbon black powder)
Specific surface area of carbon carrier (per gram of carbon carrier): 800 m²/g

### (Catalyst 2)

Type of metal: platinum particles
Number average particle size of platinum particles: 4.5 nm
Content of platinum particles relative to total mass of catalyst: 51.9 mass %
Content of carbon carrier relative to total mass of catalyst: 48.1 mass %
Type of porous carrier: carbon carrier (acetylene black powder)
Specific surface area of carbon carrier (per gram of carbon carrier): 800 m²/g

### (Catalyst 3)

Type of metal: platinum particles
Number average particle size of platinum particles: 2.4 nm
Content of platinum particles relative to total mass of catalyst: 46.9 mass %
Content of carbon carrier relative to total mass of catalyst: 53.1 mass %
Type of porous carrier: carbon carrier (graphitized carbon black powder)
Specific surface area of carbon carrier (per gram of carbon carrier): 140 m²/g

### Example 1-1

To 3.0 g of catalyst 1, 23.8 g of water and 14.1 g of ethanol were added and mixed. To the mixture, 12.5 g of liquid composition S-1 was added so as to give an I/C of 0.8 and a solids concentration of 8.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, after which 10.7 g of water, 5.1 g of ethanol, and 2.0 g of 1-propanol were added, and the resulting mixture was diluted such that the solids concentration after dispersion became 6.0 mass %, thereby obtaining a cathode catalyst layer-forming coating liquid CI-1.

### Example 1-2

To 3.0 g of catalyst 1, 25.9 g of water and 16.1 g of ethanol were added and mixed. To the mixture, 8.4 g of liquid composition S-2 was added so as to give an I/C of 0.8 and a solids concentration of 8.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, after which 10.7 g of water, 5.8 g of ethanol, and 1.3 g of 1-propanol were added, and the resulting mixture was diluted such that the solids concentration after dispersion became 6.0 mass %, thereby obtaining a cathode catalyst layer-forming coating liquid CI-2.

### Example 1-3

To 3.0 g of catalyst 1, 25.4 g of water and 15.3 g of ethanol were added and mixed. To the mixture, 9.8 g of liquid composition S-3 was added so as to give an I/C of 0.8 and a solids concentration of 8.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, after which 10.7 g of water, 5.5 g of ethanol, and 1.6 g of 1-propanol were added, and the resulting mixture was diluted such that the solids concentration after dispersion became 6.0 mass %, thereby obtaining a cathode catalyst layer-forming coating liquid CI-3.

### Example 1-4

To 3.0 g of catalyst 1, 28.2 g of water and 16.7 g of ethanol were added and mixed. To the mixture, 5.6 g of liquid composition S-4 was added so as to give an I/C of 0.8 and a solids concentration of 8.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, after which 10.7 g of water, 6.0 g of ethanol, and 1.1 g of 1-propanol were added, and the resulting mixture was diluted such that the solids concentration after dispersion became 6.0 mass %, thereby obtaining a cathode catalyst layer-forming coating liquid CI-4.

### Example 1-5

To 3.0 g of catalyst 1, 22.2 g of water and 15.8 g of ethanol were added and mixed. To the mixture, 12.4 g of liquid composition S-5 was added so as to give an I/C of 0.8 and a solids concentration of 8.0 mass %, and the resulting mixture was dispersed using a planetary ball mill (model: LP-4, manufactured by Ito Seisakusho Co., Ltd.) with mm zirconia beads at a rotation speed of 300 rpm for 180 minutes, after which 10.7 g of water, 5.7 g of ethanol, and 1.4 g of 1-propanol were added, and the resulting mixture was diluted such that the solids concentration after dispersion became 6.0 mass %, thereby obtaining a cathode catalyst layer-forming coating liquid CI-5.

### Example 1-6

To 3.0 g of catalyst 2, 23.6 g of water and 14.1 g of ethanol were added and mixed. To the mixture, 11.3 g of liquid composition S-1 was added so as to give an I/C of 0.8 and a solids concentration of 8.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, after which 18.7 g of water, 9.2 g of ethanol, and 3.3 g of 1-propanol were added, and the resulting mixture was diluted such that the solids concentration after dispersion became 5.0 mass %, thereby obtaining a cathode catalyst layer-forming coating liquid CI-6.

### Example 1-7

To 3.0 g of catalyst 3, 7.3 g of water and 9.1 g of 1-propanol were added and mixed. To the mixture, 1.9 g of liquid composition S-1 was added so as to give an I/C of 0.12 and a solids concentration of 15.0 mass %, and the resulting mixture was dispersed using a planetary ball mill (model: LP-4, manufactured by Ito Seisakusho Co., Ltd.) with 5 mm zirconia beads at a rotation speed of 300 rpm for 90 minutes, after which 15.7 g of water and 5.0 g of 1-propanol were added, 7.5 g of liquid composition S-1 was added such that the I/C after dispersion became 0.6 and the solids concentration became 8.0 mass %, and the resulting mixture was dispersed using the same planetary ball mill with 5 mm zirconia beads at a rotation speed of 300 rpm for 90 minutes, thereby obtaining a cathode catalyst layer-forming coating liquid CI-7.

### Example 1-8

To 3.0 g of catalyst 1, 24.5 g of water and 15.0 g of ethanol were added and mixed. To the mixture, 11.0 g of liquid composition S-6 was added so as to give an I/C of 0.8 and a solids concentration of 8.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, after which 10.7 g of water, 5.4 g of ethanol, and 1.7 g of 1-propanol were added, and the resulting mixture was diluted such that the solids concentration after dispersion became 6.0 mass %, thereby obtaining a cathode catalyst layer-forming coating liquid CI-8.

### Example 1-9

To 3.0 g of catalyst 1, 25.7 g of water and 15.7 g of ethanol were added and mixed. To the mixture, 9.2 g of liquid composition S-7 was added so as to give an I/C of 0.8 and a solids concentration of 8.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, after which 10.7 g of water, 5.7 g of ethanol, and 1.5 g of 1-propanol were added, and the resulting mixture was diluted such that the solids concentration after dispersion became 6.0 mass %, thereby obtaining a cathode catalyst layer-forming coating liquid CI-9.

### Example 1-10

To 3.0 g of catalyst 1, 21.6 g of water and 13.2 g of ethanol were added and mixed. To the mixture, 4.9 g of liquid composition S-8 was added so as to give an I/C of 0.8 and a solids concentration of 10.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, thereby obtaining a cathode catalyst layer-forming coating liquid CI-10.

### Example 1-11

To 3.0 g of catalyst 1, 18.0 g of water and 13.2 g of ethanol were added and mixed. To the mixture, 8.5 g of liquid composition S-9 was added so as to give an I/C of 0.8 and a solids concentration of 10.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, thereby obtaining a cathode catalyst layer-forming coating liquid CI-11.

### Example 1-12

To 3.0 g of catalyst 1, 22.7 g of water and 14.0 g of ethanol were added and mixed. To the mixture, 7.8 g of liquid composition S-1 was added so as to give an I/C of 0.5 and a solids concentration of 8.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, after which 9.5 g of water, 5.0 g of ethanol, and 1.3 g of 1-propanol were added, and the resulting mixture was diluted such that the solids concentration after dispersion became 6.0 mass %, thereby obtaining a cathode catalyst layer-forming coating liquid CI-12.

### Example 1-13

To 3.0 g of catalyst 1, 27.0 g of water and 14.4 g of ethanol were added and mixed. To the mixture, 25.0 g of liquid composition S-1 was added so as to give an I/C of 1.6 and a solids concentration of 8.0 mass %, and the resulting mixture was dispersed using a planetary ball mill (model: LP-4, manufactured by Ito Seisakusho Co., Ltd.) with 5 mm zirconia beads at a rotation speed of 300 rpm for 180 minutes, after which 13.9 g of water, 5.2 g of ethanol, and 4.0 g of 1-propanol were added, and the resulting mixture was diluted such that the solids concentration after dispersion became 6.0 mass %, thereby obtaining a cathode catalyst layer-forming coating liquid CI-13.

### [Preparation of Anode Catalyst Layer-Forming Coating Liquid AI-1]

Using liquid composition S-8 instead of liquid composition S-9, 21 g of water and 9 g of ethanol were added to 3.0 g of catalyst 1 and mixed. An anode catalyst layer-forming coating liquid AI-1 was obtained in the same manner as in example 1-11, except that 12 g of liquid composition S-8 was added to the mixture so as to give an I/C of 0.8.

### Example 1

As a polymer electrolyte membrane, an ion exchange membrane (ion exchange capacity: 1.25 meq/g dry resin) having a thickness of 25 μm and formed of a polymer having an acid-form sulfonic acid group obtained by converting SO₂F groups of a copolymer of TFE and compound 3 into SO₃H groups was provided.

The polymer electrolyte membrane was coated with the cathode catalyst layer-forming coating liquid CI-1 using a die coater such that the amount of platinum was 0.2 mg/cm², dried at 80° C. for 10 minutes, and further subjected to heat treatment at 150° C. for 15 minutes, thereby obtaining a polymer electrolyte membrane having a cathode catalyst layer CC-1 formed on one surface thereof.

Next, an ETFE (copolymer of tetrafluoroethylene and ethylene) sheet was coated with the anode catalyst layer-forming coating liquid AI-1 using a die coater such that the amount of platinum was 0.4 mg/cm², dried at 80° C. for 10 minutes, and further subjected to heat treatment at 150° C. for 15 minutes, thereby obtaining an anode catalyst layer AC-1. The polymer electrolyte membrane surface of the polymer electrolyte membrane on which the cathode catalyst layer CC-1 was formed and the anode catalyst layer AC-1 were superposed on each other and pressure-bonded at 160° C. and 3.0 MPa (absolute pressure) for 2 minutes to pressure-bond the anode catalyst layer AC-1 to the polymer electrolyte membrane, and the ETFE sheet serving as a substrate of the anode catalyst layer AC-1 was peeled off, thereby obtaining a membrane electrode assembly (electrode area: 25 cm²) ME-1.

### Example 2 to Example 13

Each membrane electrode assembly in which the anode catalyst layer AC-1, a polymer electrolyte membrane, and a cathode catalyst layer shown in the following table were disposed in this order was obtained in the same manner as in example 1, except that a cathode catalyst layer-forming coating liquid shown in the following table was used instead of the cathode catalyst layer-forming coating liquid CI-1.

### [Evaluation]

### <Power Generation Performance Durability>

The membrane electrode assemblies ME-1 to ME-13 were each incorporated into a power generation cell together with a gas diffusion layer with a microporous layer, and subjected to conditioning for 14 hours at a constant current of 0.7 A/cm². Thereafter, hydrogen (0.05 L/min)/nitrogen (0.2 L/min) was supplied under conditions of cell temperature: 80° C. and normal pressure, and 10,000 cycles were performed under conditions of anode-side dew point: 80° C., cathode-side dew point: 80° C. (in-cell relative humidity: 100% RH), voltage range: 0.6 to 1.0 V, voltage waveform: triangular wave, scan rate: 50 mV/s, and time required for one cycle: 16 sec.

Power generation performance evaluation (interim diagnosis) was performed at the 100th cycle and the 500th cycle in the initial stage of durability, and thereafter every 1,000 cycles.

In the power generation performance evaluation (interim diagnosis), hydrogen (utilization rate 70%)/air (utilization rate 50%) was supplied under conditions of cell temperature: 80° C. and back pressure: 50 kPaG, and a cell voltage (V) at current density: 1.4 A/cm², that is, a voltage value at 1.4 A/cm, was measured under conditions of anode-side dew point: 80° C. and cathode-side dew point: 80° C. (in-cell relative humidity: 100% RH). The voltage value at the 10,000th cycle (voltage value after the durability test) was determined, and evaluation was performed according to the following evaluation criteria based on a voltage drop amount, that is, a difference from the voltage value at the 500th cycle (voltage value in the initial stage of durability).

Voltage drop amount=voltage value in initial stage of durability (500th cycle)−voltage value after durability test (10,000th cycle).
“A”: The voltage drop amount is less than 0.025 V.
“B”: The voltage drop amount is 0.025 V or more and less than 0.030 V.
“C”: The voltage drop amount is 0.030 V or more and less than 0.035 V.
“D”: The voltage drop amount is 0.035 V or more.

In the table, “I/C” indicates the ratio of the mass of a fluorinated polymer to the mass of a carbon carrier in a cathode catalyst layer-forming coating liquid or in a cathode catalyst layer.

TABLE 3

| | Membrane electrode assembly | | | | | | | | | |
|---|---|---|---|---|---|---|---|---|---|---|
| | | Cathode catalyst layer | | | | | | | | |
| | | | | | Specific surface | | | | Anode | Evaluation |
| | | | | | area of carbon | Type of | Ion exchange | | catalyst | Power |
| | | | Liquid | Type of | carrier | polymer | capacity of polymer H | | layer | generation |
| | Type | Type | composition | catalyst | [m²/g] | H | [meq/g dry resin] | I/C | Type | durability |
| Example 1 | ME-1 | CC-1 | S-1 | 1 | 800 | H-1 | 1.09 | 0.8 | AC-1 | A |
| Example 2 | ME-2 | CC-2 | S-2 | 1 | 800 | H-2 | 1.00 | 0.8 | AC-1 | B |
| Example 3 | ME-3 | CC-3 | S-3 | 1 | 800 | H-3 | 0.91 | 0.8 | AC-1 | B |
| Example 4 | ME-4 | CC-4 | S-4 | 1 | 800 | H-4 | 1.07 | 0.8 | AC-1 | B |
| Example 5 | ME-5 | CC-5 | S-5 | 1 | 800 | H-5 | 0.98 | 0.8 | AC-1 | B |
| Example 6 | ME-6 | CC-6 | S-1 | 2 | 800 | H-1 | 1.09 | 0.8 | AC-1 | A |
| Example 7 | ME-7 | CC-7 | S-1 | 3 | 140 | H-1 | 1.09 | 0.6 | AC-1 | C |
| Example 8 | ME-8 | CC-8 | S-6 | 1 | 800 | H-6 | 1.23 | 0.8 | AC-1 | D |
| Example 9 | ME-9 | CC-9 | S-7 | 1 | 800 | H-7 | 1.42 | 0.8 | AC-1 | D |
| Example 10 | ME-10 | CC-10 | S-8 | 1 | 800 | H-8 | 1.10 | 0.8 | AC-1 | D |
| Example 11 | ME-11 | CC-11 | S-9 | 1 | 800 | H-9 | 1.95 | 0.8 | AC-1 | D |
| Example 12 | ME-12 | CC-12 | S-1 | 1 | 800 | H-1 | 1.09 | 0.5 | AC-1 | D |
| Example 13 | ME-13 | CC13 | S-1 | 1 | 800 | H-1 | 1.09 | 1.6 | AC-1 | D |

As shown in the above table, it has been demonstrated that power generation performance durability is excellent when the present composition is used (comparison of Examples 1 to 13).

It has been demonstrated that power generation performance durability is more excellent when the fluorinated polymer has an ion exchange capacity of 1.08 meq/g dry resin or more (comparison of Examples 1 to 6).

It has been demonstrated that power generation performance durability is more excellent when the carbon carrier has a specific surface area of 150 m²/g or more (comparison between Examples 1 to 6 and Example 7).

### REFERENCE SYMBOLS

10 membrane electrode assembly
11A, 11C catalyst layer
12A, 12C gas diffusion layer
13 anode
14 cathode
15 polymer electrolyte membrane

This application is a continuation of PCT Application No. PCT/JP2024/037607, filed on Oct. 22, 2024, which is based upon and claims the benefit of priority from Japanese Patent Application No. 2023-182747 filed on Oct. 24, 2023. The contents of those applications are incorporated herein by reference in their entireties.

What is claimed is:

1. A catalyst layer-forming composition, the composition comprising:
a fluorinated polymer that has a unit having a cyclic ether structure and has an ion exchange group;
a catalyst; and
a solvent,
wherein the fluorinated polymer has an ion exchange capacity of 1.20 meq/g dry resin or less,
the catalyst includes a carbon carrier and a metal supported on the carbon carrier, and
a ratio of a mass of the fluorinated polymer to a mass of the carbon carrier is 0.6 to 1.5.

2. The catalyst layer-forming composition according to claim 1, wherein the fluorinated polymer has a softening temperature of 160° C. or higher.

3. The catalyst layer-forming composition according to claim 1, wherein a content of the unit having a cyclic ether structure is 60 mol % or more relative to all units in the fluorinated polymer.

4. The catalyst layer-forming composition according to claim 1, wherein the carbon carrier has a specific surface area of 150 m²/g or more.

5. The catalyst layer-forming composition according to claim 1, wherein the metal is platinum or a platinum alloy.

6. The catalyst layer-forming composition according to claim 1, wherein the fluorinated polymer has an ion exchange capacity of 0.90 to 1.20 meq/g dry resin.

7. A catalyst layer comprising:
a fluorinated polymer that has a unit having a cyclic ether structure and has an ion exchange group; and
a catalyst,
wherein the fluorinated polymer has an ion exchange capacity of 1.20 meq/g dry resin or less,
the catalyst includes a carbon carrier and a metal supported on the carbon carrier, and
a ratio of a mass of the fluorinated polymer to a mass of the carbon carrier is 0.6 to 1.5.

8. A membrane electrode assembly comprising an anode having a first catalyst layer, a cathode having a second catalyst layer, and a polymer electrolyte membrane disposed between the anode and the cathode,
wherein the second catalyst layer is the catalyst layer as defined in claim 7.

9. A polymer electrolyte fuel cell comprising the membrane electrode assembly as defined in claim 8.
